(19) United States
(12) Patent Application Publication
(10) Pub. No.: US 2010/0328646 A1
(43) Pub. Date: Dec. 30, 2010

(54) OPTICAL NANOPOROUS SENSORS FOR DETECTION OF WATER BASED VAPORS AND THEIR LEAKAGE FROM SEALED CONTAINERS

(75) Inventor: Igor A. Levitsky, Fall River, MA (US)

Correspondence Address: Igor Levitsky, 150 Harvard St., Fall River, MA, 02720, US

(73) Assignee: Emitech, Inc., Fall River, MA (US)

(21) Appl. No.: 12/492,150

(22) Filed: Jun. 26, 2009

(51) Int. Cl. G01N 21/55

(52) U.S. Cl. 356/51; 356/445

(57) ABSTRACT

An optical sensor for detecting water vapors and water based vapors and comprising a semiconductor member having a semiconductor surface with hydrophilic pores therein. An illumination of the semiconductor surface by white light produces the reflectance spectral profile due to light spectral. The spectral profile is exposed to the water vapors and the change in the reflectance spectral response is measured during this exposure.

### FIELD OF THE INVENTION

The present invention relates to a novel method for the precise detection of water vapors and water based vapors, which can be applied to leakage detection of sealed containers with water based liquids. This method discloses the fabrication and application of new optical sensors based on nanoporous semiconductors with a reflectance spectral profile, which is sensitive to the water vapor pressure.

### BACKGROUND OF THE INVENTION

Porous silicon (PSi) chemical and biological optical sensors have been intensively studied for the past decade because of the high surface area of PSi and the variety of optical transduction mechanisms upon exposure to different analytes. Optical sensors based on PSi one-dimensional photonic crystals with microcavity (MC) (Mulloni et al, Appl. Phys. Lett. 76: 2523, 2000; Chan et al, J. Am. Chem. Soc. 123: 11797, 2001; Lin et al, Science 278: 840, 1997; De Stefano et al, Appl. Optics 43: 167, 2004; Levitsky et al, Appl. Phys. Lett. 90: 04194, 2007) demonstrated better sensitivity than PSi monolayers or Bragg mirrors due to the existence of a sharp resonance peak whose spectral position depends on the change of the MC refractive index. In the case of the vapor sensing, two major mechanisms responsible for the refractive index change can be considered: capillary condensation (relatively high vapor pressure) and physisorption on the inner walls of PSi (low vapor pressure). In addition, for porous photonic crystals with MC infiltrated with sensory polymers (Levitsky et al, Appl. Phys. Lett. 90: 04194, 2007), chemisorption contributes to the refractive index change.

Janshoff et al (J. Am. Chem. Soc. 120:12108; 1998) also describe the PSi for biosensor applications utilizing a shift in a Fabry-Perot fringe pattern, created by multiple reflections of illuminated white light on the air/PSi layer and PSi/bulk silicon interface, as a means for detecting molecular interactions of species in a solution with immobilized ligands as receptors.

U.S. Pat. No. 6,780,649 (Armstrong et al) describes the PSi layer modified with recognition elements. A PSi layer has its own photoluminescence (PL). A PSi modified with such recognition elements can interact with a target analyte so that a wavelength shift and/or change in PL intensity. Thus, transduction mechanism in these sensors is photoluminescence of PSi, but not of the sensory element itself.

U.S. Pat. No. 7,226,733 (Fauchet et al) describes a biological sensor comprising of a porous semiconductor structure including strata of alternating porosity; and one or more probes coupled to the porous semiconductor structure. The probes that are binding to a target molecule result in change in a refractive index of the biological sensor upon binding of more probes to the target molecule.

Among variety of vapors tested by PSi MC optical sensors, just a few reports are related to humidity sensing (Mulloni et al, Appl. Phys. Lett. 76: 2523, 2000; Barrato et al, Sensors 1: 121, 2002) probably because the MC resonance peak in these studies was almost unresponsive to the humidity change (e.g. 0.4 nm red shift from dry to 50% relative humidity (Barrato et al, Sensors 1: 121, 2002). Mulloni et al, Appl. Phys. Lett. 76: 2523, 2000 reported no change of the MC peak spectral position even for immersion of MC in water. It is worth mentioning that MCs in these reports were not oxidized at high temperatures under oxygen or at normal conditions with ozone exposure. As a result, the porous surface was terminated mostly by Si—H groups making it hydrophobic, which prevents water vapor condensation.

Existing sensors for humidity are mostly based on conductive or capacitance changes upon exposure to water vapors (Fujes et al, Sens. Actuat. B 95: 140, 2003; Rittersma et al, Sens. Actuat. B 68: 210, 2000; Mares et al, Thin Solid Films 255: 272, 1995). However, their performance suffers from environmental conditions due to contact corrosion and degradation. In addition, their sensitivity to humidity change is not sufficient in many cases.

It would therefore be desirable to have optical sensors that can detect water vapors without electrical and mechanical parts in order to provide a good durability and high sensitivity.

### SUMMARY OF THE INVENTION

The present invention provides an approach for the development of optical sensors for detecting water based vapors and their leakage from the sealed containers.

In this invention, the sensory part of the device is comprised of a nanoporous semiconductor (monolayer or photonic crystal with microcavity), pore size of 2-20 nm with porosity less than 50%. For porous monolayer the reflectance spectrum is patterned by Fabry-Perot fringes. For the photonic crystal with microcavity (FIG. 1), the broad stop band in the reflectance spectrum is patterned by a narrow resonance peak as a result of the light spectral in the photonic crystal. The exposure of the nanoporous structure by the water or water based vapors affect the reflectance spectrum by shifting the spectral position of the microcavity resonance peak (or Fabry-Perot fringes) as a result of the refractive index change due to water condensation inside nanopores. Then the time trace of the reflectance intensity upon the water vapors exposure at different wavelengths should be different in the vicinity of the microcavity resonance peak. Alternatively, the spectral position of the microcavity resonance peak can be monitored. Thus, intensities of the reflectance or spectral position of resonance peak correlates with the water vapors concentration or relative humidity level. In the following we will consider the response of the optical sensors based on photonic crystal with microcavity only, as it demonstrates more pronounced effect as compared with Fabry-Perot fringes. However, the principles of the present invention are considered as covering both photonic crystal with microcavity and Fabry-Perot types.

For detection of water based vapors, it is important that inner walls of semiconductor nanopores are hydrophilic. For this purpose the nanoporous structure should be intensively oxidized at high temperatures (˜1000° C.) under oxygen flow or chemically treated. FIG. 1b shows the reflectance spectrum of silicon nanoporous photonic crystal with microcavity before and after oxidation. Without strong oxidation, resonance peak is almost non-responsive on the humidity change (see Mulloni et al, Appl. Phys. Lett. 76: 2523, 2000; Barrato et al, Sensors 1: 121, 2002).

More particularly there is provided a optical sensor for detecting water based vapors and comprising a semiconductor substrate having a surface with semiconductor nanopores therein, means for exposing the nanoporous structure to the water based vapors, wherein a reflection of said semiconductor porous material results in reflectance spectral profile due to spectral of the reflected light, and means for measuring the change in the reflectance spectral profile during said exposure.

In accordance with other aspects of the present invention, per one or more of the following features, the intensity of the reflectance is monitored on a real-time basis as time traces during the vapor exposure at least two different wavelengths of the reflectance spectral profile or as a spectral shift of one or multiple peaks of the reflectance spectral profile; including monitoring the time traces of the reflectance intensity or spectral shift as relates to at least one factor affecting reflectance spectral profile due to a change of the refractive index upon water vapor exposure; wherein the reflectance spectral profile is caused by the multiple light reflection and spectral inside the semiconductor pores; wherein the reflectance spectral profile is caused by Fabry-Perot fringes of porous monolayer or narrow peak of photonic crystal with microcavity fabricated by multiple layers of alternating porosity; wherein said semiconductor pores have size in the range of 2-20 nm and made in semiconductor bulk material to provide the light spectral for reflected and light; wherein porous microcavity or porous monolayer are situated on a top of the bulk semiconductor material and from which they are fabricated; wherein porous microcavity or porous monolayer are prepared as a free standing membrane; wherein the semiconductor is selected from the group consisting of Group II/VI semiconductors, Group III/V semiconductors and Group IV semiconductors; wherein the semiconductor is selected from the group consisting of Cds, CdSe, InP, GaAs, Ge, Si and doped Si.

Also, in accordance with the present invention there is provided a method of detecting water or water based vapors employing at least one porous semiconducting material, comprising the steps of:
illumination by the white light, said at least one porous semiconducting material resulting in a reflectance spectral profile;
exposing the reflectance spectral profile to the target vapor;
and measuring the change of the reflectance spectral profile during such exposure.

In accordance with still other aspects of the present invention, per one or more of the following features, the step of measuring the reflectance spectral profile includes measuring the change of the reflectance intensity at least at two different wavelengths from the reflectance profile or as a spectral shift of one or multiple peaks of the reflectance spectral profile; the reflectance profile is selected from one of Fabry-Perot fringes of a porous monolayer or the resonance peak of photonic crystal with MC fabricated by multiple layers of alternative porosity; the step of measuring includes real-time monitoring of the reflectance intensity at different wavelengths or as a spectral shift of one or multiple peaks selected from the reflectance spectral profile upon vapor exposure.

In addition, in accordance with the present invention there is provided a method of detecting leakage and seal integrity of containers with water or water based liquids employing at least one porous semiconducting material, comprising the steps of:
gripping the container and soaking the air so that to expose, said porous semiconducting material;
illumination by the white light, said at least one porous semiconducting material resulting in a reflectance spectral profile;
and measuring the change of the reflectance spectral profile during such exposure
   In accordance with still other aspects of the present invention, per one or more of the following features, the step of measuring the reflectance spectral profile includes measuring the change of the reflectance intensity at least at two different wavelengths from the reflectance profile or as a spectral shift of one or multiple peaks of the reflectance spectral profile; detecting analytes are water and water based vapors emanated from any soft and hard drinks produced in the food industry (e.g. Coca-Cola, tea, coffee, lemonade, wine, whiskey, etc), any water based liquids produced in the biomedical industry (e.g. vaccines, intravenous fluids, serums, plasmas, etc), and chemical industry (influent water, drilling fluid, etc).

### DESCRIPTION OF THE DRAWINGS

FIG. 1(a): Cross-sectional SEM image of a porous Si one-dimensional photonic crystal with microcavity (MC). The schematic of this structure can be as DBR1/MC/DBR2. First distributed Bragg reflector (DBR1) and second DBR2 contains 5 and 20 periods of porous silicon multilayers of high and low porosity. The 200 nm thick MC layer is between DBR1 and DBR2.

FIG. 1(b): Reflectance spectra of the fresh prepared PSi photonic crystal with MC (dashed line) and after annealing (solid line).

FIG. 2: (a) Dependence of the spectral shift of MC resonance peak on RH % at 22° C. and (b) MC peak spectral position for RH=20% and RH=80%.

FIG. 3: (a) Dependence of the spectral shift of MC resonance peak on air pressure, at RH=80% and (b) MC spectral position for vacuum pressure of 105 Pa and normal pressure 5×10³ Pa.

FIG. 4: Time traces of the normalized reflectance for ON/OFF cycle of applied vacuum, Reflectance intensities were taken on the half of the width of MC resonance peak for short wavelength (dash line) and long wavelength (solid line) shoulders. Air pressure is 5×10³ Pa

FIG. 5: A schematic diagram of one embodiment of an apparatus used to detect leakage from sealed containers

### DETAILED DESCRIPTION

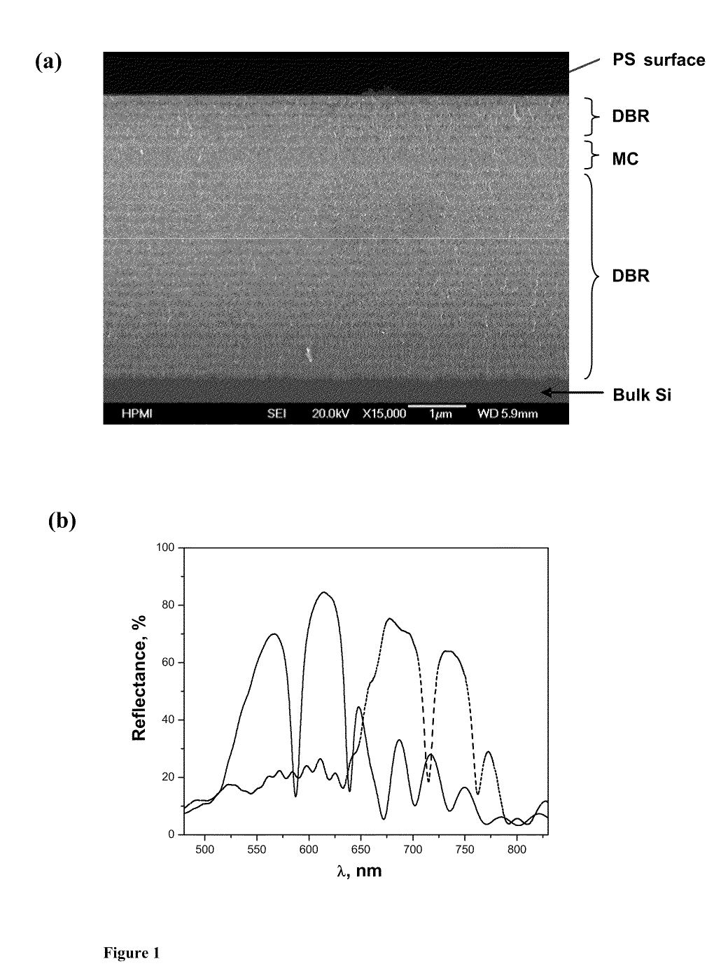

The use of a porous photonic crystal with microcavity (MC) for vapor sensing is not new and optical sensors based on reflectance in MC have been already reported (see references in the “background of invention” section). The most developed porous photonic crystals are made by electrochemical etching from bulk Si (p and n type). Introduction of MC layer between two Distributed Bragg Reflectors (DBRs) result in the sharp resonance peak (FWHM˜10 nm) in the broad stop band (FIG. 1) due to spectral of the reflected light. Among variety of vapors tested in PSi MC optical sensors, just a few reports are related to humidity sensing (Mulloni et al, Appl. Phys. Lett. 76: 2523, 2000; Barrato et al, Sensors 1: 121, 2002) probably because the MC resonance peak in these studies was almost unresponsive to the humidity change (e.g. 0.4 nm red shift from dry to 50% relative humidity (Barrato et al, Sensors 1: 121, 2002). Mulloni et al, (Appl. Phys. Lett. 76: 2523, 2000) reported no change of the MC peak spectral position even for immersion of MC in water. It is worth mentioning that MCs in these reports were not oxidized at high temperatures under oxygen or at normal conditions with ozone exposure. As a result, the porous surface was terminated mostly by Si—H groups making it hydrophobic, which prevents water vapor condensation.

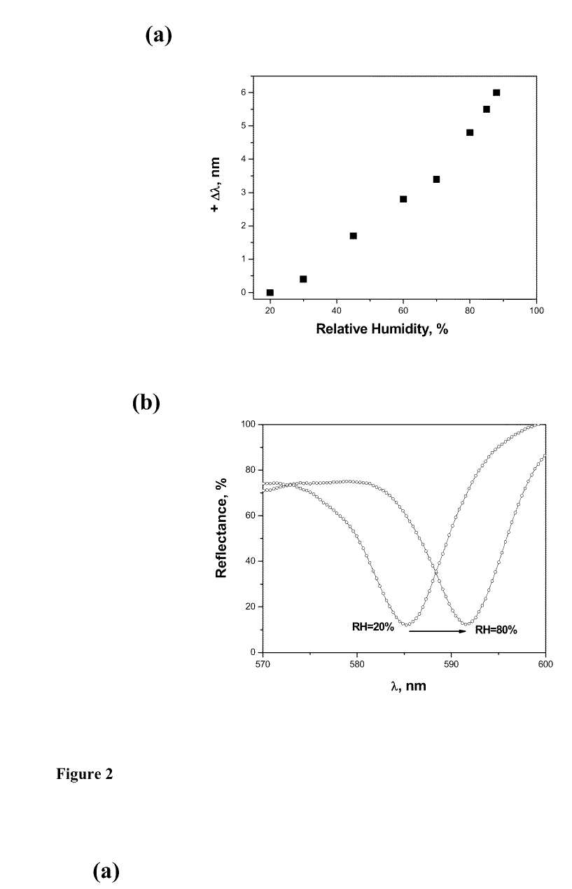

In the presented invention, MC peak spectral position demonstrates strong dependence on the concentration of the water vapors: a spectral shift up to 6 nm at increasing of relative humidity (RH) from 20% to 90% (FIG. 2). This effect is the result of the strong oxidation of porous Si (PSi) MC at high temperatures (˜1000° C.) under oxygen, making the Si porous surface hydrophilic. Thus, the effective oxidation of PSi MC structure is a critical issue for water based vapor sensing. FIG. 1b shows the reflectance spectrum of silicon nanoporous photonic crystal with microcavity prior to and after oxidation. Without strong MC oxidation, the resonance peak is almost irresponsive on the humidity change (see Mulloni et al, Appl. Phys. Lett. 76: 2523, 2000; Barrato et al, Sensors 1: 121, 2002).

Briefly, PSi MCs were prepared by anodic etching of p-type (100)-oriented Si wafers (resistivity˜0.01 ohm·cm) in 15% solution of HF with ethanol. Anodization was performed under a periodically changing current applied between a silicon wafer and a platinum electrode. In some fabricated samples (FIG. 1a), the first DBR consists of 5 periods while the second has 20 periods; each period contains two layers, high and low porosity. The low and high porosity layers were fabricated at a current density of 6 mA/cm² and 25 mA/cm², respectively. MC oxidation was done at 900° C. under oxygen flow. The reflectance spectra were measured with an Ocean Optics spectrometer coupled with an optical fiber positioned normal to the sample surface. Samples were placed in custom designed flow cell equipped with the flow controller to regulate the humidity or vacuum level.

Another example shows as a pore size affects on the detector sensitivity. Five PSi monolayers of different porosity were prepared (Table 1). As shown in Table 1, there is a correlation between the spectral shift of the Fabry-Perot fringes and porosity of the monolayers. The highest spectral shift (4 nm for vacuum and 2.5-3 nm for ultrasound) is observed for monolayer with low porosity (43%) and practically no shift was detected for high porosities (more than 75%). These results are in a good agreement with the capillary condensation model, where the average pore radius is responsible for critical vapor condensation inside the mesopores. This process can be described by the Kelvin formula (S. J Gregg, K. S. Sing, Adsorption, Surface Area and Porosity, 2 nd ed, Acad. Press, London 1982, p. 112) for relative vapor pressure P at which condensation occurs for pores of radius r:

$$\frac{P}{{P}_{S}} = exp ( - \frac{γ {V}_{L}}{RTr} ) \qquad ( 1 )$$

where γ is the surface tension of the liquid, V_{L} is the molar volume of the liquid, R is the gas constant, T is temperature, and P_{S} is the saturation vapor pressure of the liquid. Thus, pores with small radius (low porosity) facilitate and make more effective water vapor condensation as compared with pores with the large radius (high porosity)

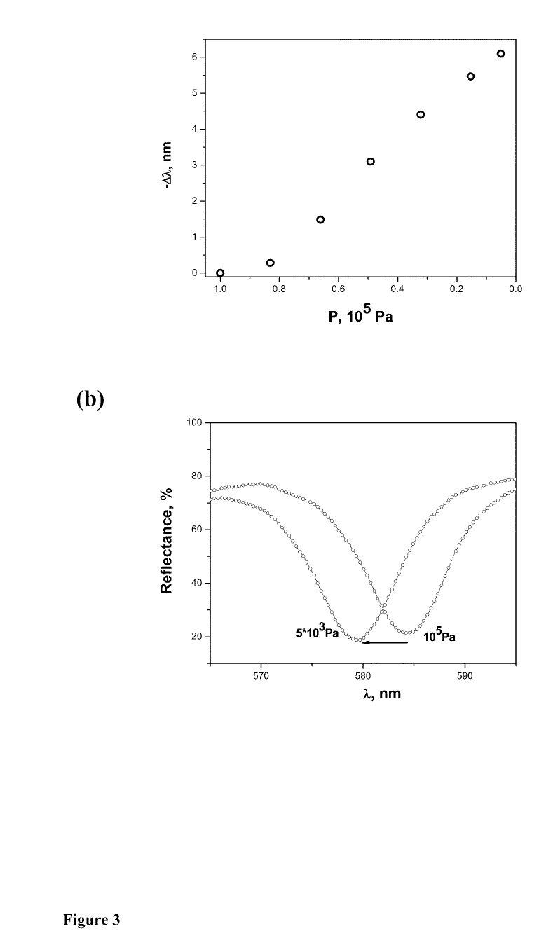

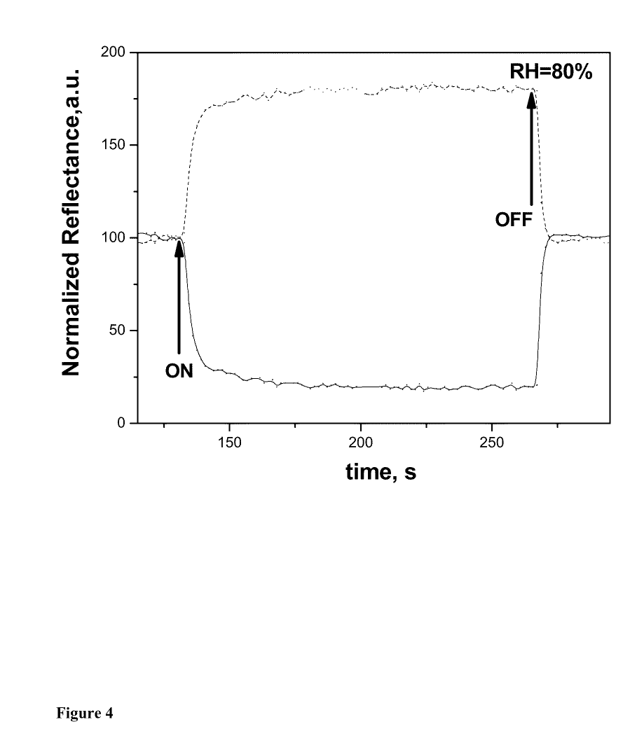

Another example shows the effect of water removal (FIG. 3) under vacuum from PSi MC structure, when RH changes from 80% (vacuum) to 0% (normal pressure). The MC peak demonstrates a shift to shorter wavelengths upon vacuum increase. The total shift under vacuum is almost the same as at RH change from 20% to 90% (FIG. 2), which is in a good agreement with the proposed model. Dynamics of the water removal from PSi MC sensor under vacuum and its recovery at normal pressure is shown in FIG. 4. The sensor recovery time should be similar to the response time, as the fast increase of the pressure (usually takes ˜1-2 s) forces the water molecules to quickly infiltrate back into the nanoporous structure. This assumption is consistent with experimental results (FIG. 4).

Thus, in accordance with the present invention, unlike that described in the prior art, PSi photonic crystal with MC or porous monolayer can be employed as an efficient and accurate optical sensor for water vapors and water based vapors. Water based vapors could include any vapors emanated from soft and hard drinks produced in the food industry (e.g. Coca-Cola, tea, coffee, lemonade, wine, whiskey, etc), any water based liquids produced in the biomedical industry (e.g. vaccines, intravenous fluids, serums, plasmas, etc), and chemical industry (influent water, drilling fluid, etc). In the presented invention, semiconducting nanoporous material is not confined by silicon only and can be extended to other semiconductors selected from group II/VI semiconductors, group III/V semiconductors and group IV semiconductors (Cds, CdSe, InP, GaAs, Ge, etc).

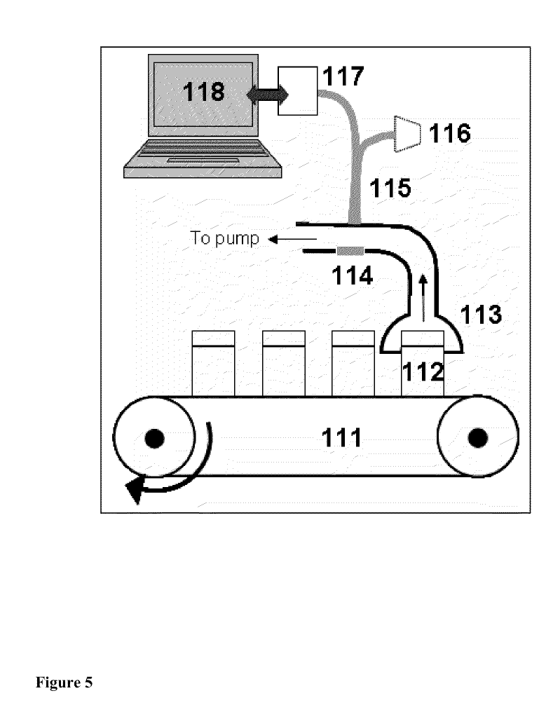

Finally, the present invention can be used for detecting leakage and seal integrity of containers with water or water based liquids. FIG. 5 demonstrates the schematic of the proposed method and related apparatus comprising the steps of:
gripping the container and soaking the air so that to expose, said porous semiconducting material;
illumination by the white light, said at least one porous semiconducting material resulting in a reflectance spectral profile;
and measuring the change of the reflectance spectral profile during such exposure.
   The sensory system for leakage detection is installed over a conveyer belt (111) with cans (112) containing water based liquid. Vacuum grip (113) embraces each can's cap and soaks the air. The flow passes over the sensory element (114) composed of the PSi MC, which is illuminated by the light source (116) through a bifurcated optical fiber (115). The second end of the fiber is connected to a data acquisition system/minispectrometer (117), which is coupled to the processor/interface (118). In the case that the seal is intact, the spectral shift should be maximal, similar to the shift in FIG. 3. In case of leakage, the sensory element is exposed to the water based vapor resulting in a smaller shift as compared to when the seal is intact. Thus, the leakage in a sealed cap can be detected.

What is claimed is:

TABLE 1
Characteristics of PSi monolayers of different porosity and the
spectral shift (−Δλ_{P}) of their Fabry-Perot fringes
(at 600 nm) upon pressure change from the normal condition
to the vacuum.

| Samples | I mA/cm² | Porosity, % | −Δλ_{VAC}, nm^{a)} | n_{eff} | Δ n_{eff}/n_{eff}^{b)} |
|---|---|---|---|---|---|
| 1 | 5 | 43.5 | 4 | 3.4 | 6.9 * 10⁻³ |
| 2 | 10 | 51.0 | 2 | 3.2 | 3.4 * 10⁻³ |
| 3 | 30 | 61.2 | 1.6 | 3.0 | 2.7 * 10⁻³ |
| 4 | 60 | 75.2 | ~0.8 | 2.3 | — |
| 5 | 80 | 83.7 | — | 1.8 | — |

^{a)}Spectral shift was detected for vacuum of 5 × 10³ Pa. Initial relative humidity at normal conditions corresponds to the level of RH = 80%
^{b)}Refractive index n_{eff} was calculated according to formula n_{eff} = 2d(λ λ₁)/(λ − λ₁), where d = 2 μm (±10%) for all monolayers, and Δ n_{eff} = n_{eff} 2d Δλ/λ₁

1. An optical sensor for detecting water vapors or water based vapors and comprising a semiconductor wafer having a surface with semiconductor pores therein, means for exposing porous semiconductor to the water or water based vapors, wherein a reflection of said semiconductor porous material results in reflectance spectral profile due to spectral of the reflected light, and means for measuring the change in the reflectance spectral profile during said exposure.

2. The optical sensor of claim 1 wherein the intensity of the reflectance is monitored on a real-time basis as time traces during the vapor exposure at least two different wavelengths or as a spectral shift of one or multiple peaks of the reflectance spectral profile.

3. The optical sensor of claim 2 including monitoring the time traces of the reflectance intensity or spectral shift as relates to at least one factor affecting reflectance spectral profile due to a change of the refractive index upon vapor exposure.

4. The optical sensor of claim 2 wherein the reflectance spectral profile is caused by Fabry-Perot fringes of porous monolayer or by narrow peak of photonic crystal with micro cavity fabricated by multiple layers of alternating porosity.

5. The optical sensor of claim 2 wherein spectral shift of one or multiple peaks of the reflectance spectral profile is more than 2 nm in the visible and near IR spectral range.

6. The optical sensor of claim 1, wherein said inner surface of the semiconductor pores has hydrophilic properties as a result of thermal oxidation or special chemical treatment.

7. The chemical sensor of claim 1, wherein said semiconductor pores have size in the range of 2-20 nm and porosity less than 50% and made in semiconductor bulk material to provide the light spectral for reflected and emissive light

8. The optical sensor of claim 1, wherein porous photonic crystal with microcavity or porous monolayer is situated on a top of the bulk semiconductor material and from which they are fabricated.

9. The optical sensor of claim 1, wherein porous photonic crystal with microcavity or porous monolayer are prepared as a free standing membrane.

10. The chemical sensor of claim 8, wherein the semiconductor is selected from the group consisting of Group II/VI semiconductors, Group III/V semiconductors and Group IV semiconductors.

11. The chemical sensor of claim 8, wherein the semiconductor is selected from the group consisting of Cds, CdSe, InP, GaAs, Ge, Si and doped Si.

12. The optical sensor of claim 1, wherein detecting analytes are water and water based vapors emanated from any soft and hard drinks produced in the food industry (e.g. Coca-Cola, tea, coffee, lemonade, wine, whiskey, etc), any water based liquids produced in the biomedical industry (e.g. vaccines, intravenous fluids, serums, plasmas), and chemical industry (influent water, drilling fluid).

13. A method of detecting target water or water based vapors employing at least one porous semiconducting material, comprising the steps of:
illumination by the white light, said at least one porous semiconducting material resulting in a reflectance spectral profile;
exposing the reflectance spectral profile to the target vapor;
and measuring the change of the reflectance spectral profile during such exposure.

14. The method of claim 13 wherein the step of measuring the reflectance spectral profile includes measuring the change of the reflectance intensity at least at two different wavelengths or the spectral shift of one or multiple peaks from the reflectance spectral profile.

15. The method of claim 13 wherein the reflectance profile is selected from one of Fabry-Perot fringes of a porous monolayer or the resonance peak of photonic crystal with microcavity fabricated by multiple layers of alternating porosity

16. The method of claim 13 wherein the step of measuring includes the real-time monitoring of the reflectance intensity upon the vapor exposure at different wavelengths selected from the reflectance spectral profile

17. The method of claim 13 including monitoring the time traces of the reflectance intensity as relates to at least one factor affecting reflectance spectral profile due to a change of the refractive index upon vapor exposure.

18. The method of claim 13, wherein detecting analytes are water and water based vapors emanated from any soft and hard drinks produced in the food industry (e.g. Coca-Cola, tea, coffee, lemonade, wine, whiskey, etc), any water based liquids produced in the biomedical industry (e.g. vaccines, intravenous fluids, serums, plasmas, etc), and chemical industry (influent water, drilling fluid, etc).

19. A method of detecting leakage and seal integrity of containers with water or water based liquids employing at least one porous semiconducting material, comprising the steps of:
gripping the container and soaking the air so that to expose, said porous semiconducting material;
illumination by the white light, said at least one porous semiconducting material resulting in a reflectance spectral profile;
and measuring the change of the reflectance spectral profile during such exposure.

20. The method of claim 19, wherein detecting analytes are water and water based vapors emanated from any soft and hard drinks produced in the food industry (e.g. Coca-Cola, tea, coffee, lemonade, wine, whiskey, etc), any water based liquids produced in the biomedical industry (e.g. vaccines, intravenous fluids, serums, plasmas, etc), and chemical industry (influent water, drilling fluid, etc).
